(19) United States
(12) Patent Application Publication
(10) Pub. No.: US 2003/0096585 A1
(43) Pub. Date: May 22, 2003

(54) Radiocommunications device including a heat dissipation system

(75) Inventors: OLivier Danet, Osny (FR); Rene Le Quere, Le Plessis Bouchard (FR); Jose Marie Baro, Taverny (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/294,763

(22) Filed: Nov. 15, 2002

(30) Foreign Application Priority Data
Nov. 16, 2001 (FR) 01 14 866

(51) Int. Cl. H04B 1/38; H04B 1/04; H01Q 11/12; H04M 1/00

(52) U.S. Cl. 455/117; 455/90; 455/550

(57) ABSTRACT

A radiocommunications device comprising an antenna (20) and a power amplifier (24) connected to a printed circuit (26), the device being characterized in that the mass (21) of the antenna (20) and the mass (22) of the power amplifier (24) are thermally connected.

The present invention relates to a radiocommunications device comprising an antenna and a printed circuit connected together by a power amplifier.

A non-exclusive field of application of the invention is that of mobile radiocommunications terminals operating in a cellular radiocommunications system. The invention applies particularly but not exclusively, to a system complying with the global system for mobile communications (GSM) and the general packet radio service (GPRS) standards.

### BACKGROUND OF THE INVENTION

With the technological progress in mobile terminals, it is becoming inevitable that the thermal aspects associated with power amplifiers need to be taken into consideration, since the amount of power dissipated is increasing, and the lifetime of terminals is affected thereby. Power amplifiers comprise a plurality of transistors having connections with the printed circuit that manages the memory of the mobile terminal, and these connections are subjected to transient thermal stresses.

While the terminal is in operation, the radio frequency (RF) signal is transmitted or received only for a determined length of time at a periodicity that is fixed by the reference clock of the network, i.e. in the form of a squarewave signal as shown in FIGS. 1A and 1B.

When a terminal is used in a GSM network, the signal is as shown in FIG. 1A and components such as power amplifiers dissipate power by the “Joule effect” to the printed circuit and to the surrounding air during stages in which the RF signal is maintained or in which it is rising/falling, since the energy conversion efficiency of such components is less than 100%.

Thus, because of this power that is dissipated during the ON-time, power amplifiers are subjected to a temperature pulse.

Over a longer period of time, the succession of temperature pulses stabilizes asymptotically towards a temperature that can be high.

FIG. 1A illustrates the fact that the power amplifiers are subjected to a sudden voltage step 1, and then at the end of the pulse 2 they are subjected to a sudden drop in voltage 3, followed by an OFF-time 5.

Thus, these components are subjected to a sudden rise in temperature followed by maintaining a high temperature, followed by a sudden drop in temperature.

These operating conditions for the power amplifiers are even more extreme for a terminal operating in a GPRS network than when operating in a GSM network, since the power-ON squarewave signal is then as shown in FIG. 1B.

This can be seen by comparing FIGS. 1A and 1B. The two signals are compared over a common period T of 4.615 milliseconds (ms). It can be seen that the voltage rise 6 in the GPRS signal is 1.5 times the size of the voltage rise 1 in the GSM signal.

The pulse 7 in the GPRS signal can be four times as long as the pulse 2 in the GMS signal, i.e. 2.308 ms as compared with 0.577 ms, and the OFF-time 10 after the voltage drop 8 in the GPRS signal (no more than 0.5×4.615 ms) is shorter than the OFF-time 5 after the voltage drop 3 in the GSM signal.

Thus, the temperature of the transistors in the power amplifiers is higher when the terminal is used in a GPRS network than when it is used in the GSM network.

Unfortunately, the temperature limits imposed on the semiconductor material of power amplifiers, whose maximum operating temperatures differ as a function of the nature of the material used (175° C. maximum for silicon, 150° C. maximum for gallium arsenide), show that an increase in 25° C. in the temperature of the connection between the power amplifier transistor and the printed circuit can double the number of breakdowns. In this example, the temperature goes from 35° C. for the GSM network to 50° C. for the GPRS network.

In particular, the effect of temperature can be seen on:

the electrical performance of the power amplifier due to drift and thermal runaway phenomena;

the mechanical behavior of the power amplifier package (e.g. problems with solder);

thermal cycling (tensions associated with different expansion coefficients for different parts making up the power amplifier); and

the reliability of the power amplifier.

Thus, using the terminal in GPRS mode leads to premature aging of its power amplifier.

In addition, the present trend is to integrate power amplifiers in packages that are increasingly miniaturized. Thus, the ratio of power dissipated to amplifier area is tending to increase.

For all of these reasons associated with technological development of mobile terminals, it is essential to limit the temperature rise of the components of terminals since otherwise the lifetime of such terminals will be significantly shortened.

A prior art solution, shown in FIG. 2, is to insert a copper plate 17 between the printed circuit 26 and the connection 15 of the power amplifier transistor 24 with the printed circuit 26. This plate serves to absorb a fraction of the heat power dissipated by the power amplifier 24.

This adds an additional step in the method of manufacture, adds material cost, and lengthens qualification time, and is therefore too expensive, and in addition the amount of heat power that can be absorbed runs the risk of decreasing over time.

### OBJECTS AND SUMMARY OF THE INVENTION

An object of the invention is to mitigate those drawbacks by providing a mobile terminal that is less expensive, more efficient, and more reliable, and in which the temperature rise of the power amplifier is limited.

In particular, the invention proposes dissipating a fraction of the heat power from the power amplifier 24 by means of the antenna 20 of the device.

To this end, the invention proposes a radiocommunications device comprising an antenna 20 and a power amplifier 24 connected to a printed circuit 26, the device being characterized in that the mass 21 of the antenna 20 and the mass 22 of the power amplifier 24 are thermally connected.

In an embodiment, the mass 21 of the antenna 20 is fixed between the mass 22 of the power amplifier 24 and the printed circuit 26.

In another embodiment, the mass 21 of the antenna 20 is fixed to the face of the printed circuit 26 that is opposite from the face on which the mass 22 of the power amplifier 24 is fixed.

In other embodiments, the mass 21 of the antenna 20 is thermally connected to the mass 22 of the power amplifier 24 by thermal bridges, or by plated-through holes 32 passing through the printed circuit 26.

### BRIEF DESCRIPTION OF THE DRAWINGS

Other characteristics and advantages of the invention appear on reading the following description of a particular embodiment of the invention, given by way of non-limiting illustration, and from the drawings listed below.

FIGS. 1A and 1B, described above in the introduction to the description, serve to compare GSM and GPRS signals.

FIG. 2, described above, is a diagram showing a printed circuit including a prior art power amplifier.

FIG. 3A is a diagrammatic section view of a printed circuit including a power amplifier constituting a first embodiment of the invention.

FIG. 3B is a diagrammatic perspective view showing a printed circuit including a power amplifier in a first embodiment of the invention.

FIG. 4 is a diagram of a printed circuit including a power amplifier in a second embodiment of the invention.

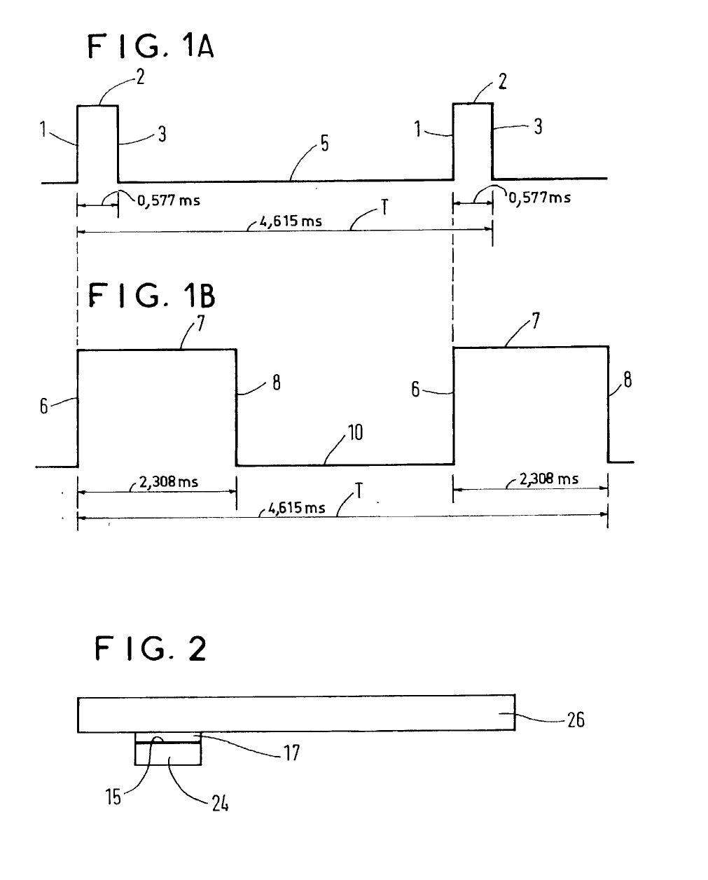

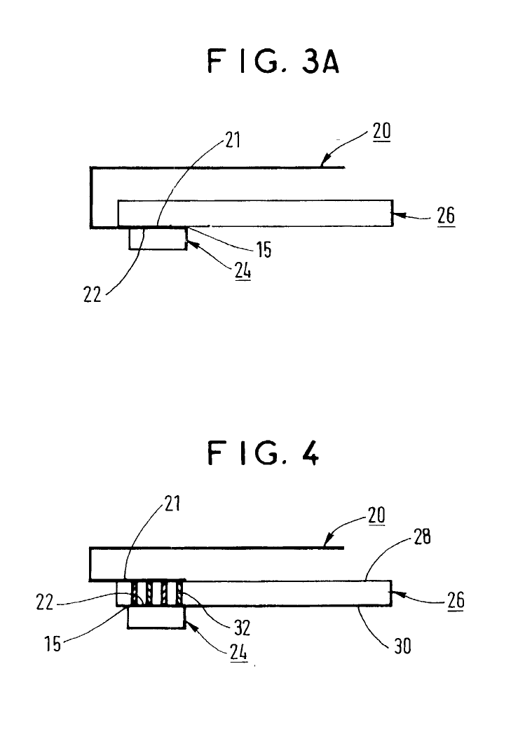

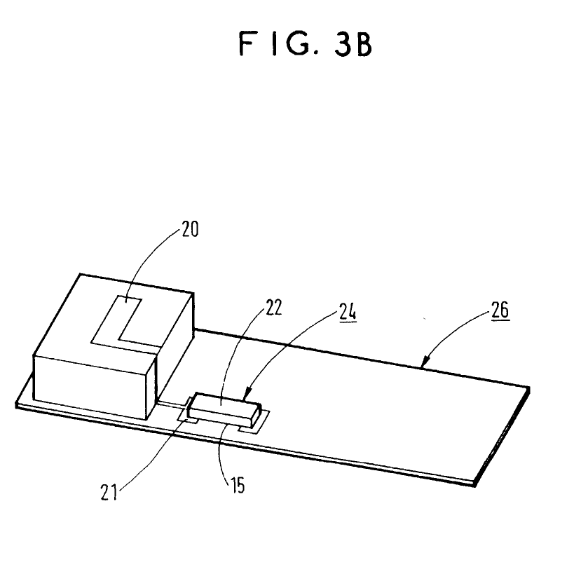

FIGS. 3A and 3B show the mass 21 of the antenna 20 of a terminal being fixed, e.g. by solder, between the mass 22 of the transistor of the power amplifier 24 and the printed circuit 26. The antenna 20 shown in this example is a patch type antenna.

### MORE DETAILED DESCRIPTION

Thus, the antenna 20 which is of large surface area can very easily dissipate the heat power given off by the power amplifier 24.

This reduces temperature since a fraction of the heat power can be dissipated via the terminal antenna 20.

The antenna 20 is of larger area than the connection 15 between the transistor and the printed circuit 26. It is thus capable of dissipating the heat power given off by the power amplifier 24 much more easily.

The operating point of the power amplifier 24 is therefore not modified by excess temperature which would harm proper operation and can lead to numerous breakdowns.

Nevertheless, in particular with a patch type antenna, it is important to maintain a magnetic resonance cavity that is empty of any foreign elements, whence the second possible embodiment of the invention in which the cavity of the antenna 20 does not contain the printed circuit 26.

FIG. 4 shows the mass 21 of the antenna 20 of the terminal fixed by solder to the face 28 of the printed circuit 26 that is opposite from the face 30 of the printed circuit 26 on which the power amplifier 24 is soldered. Heat power is dissipated via thermal bridges, e.g. plated-through holes 32 made between the two faces 28 and 30 of the printed circuit.

Furthermore, no additional element is added to the existing device for dissipating the heat power given off by the power amplifier 24.

Finally, the device can be assembled during manufacture without requiring any subsequent action to be taken.

What is claimed is:

1/ A radiocommunications device comprising an antenna (20) and a power amplifier (24) connected to a printed circuit (26), the device being characterized in that the mass (21) of the antenna (20) and the mass (22) of the power amplifier (24) are thermally connected.

2/ A device according to the preceding claim, characterized in that the mass (21) of the antenna (20) is fixed between the mass (22) of the power amplifier (24) and the printed circuit (26).

3/ A device according to claim 1, characterized in that the mass (21) of the antenna (20) is fixed on the face (28) of the printed circuit (26) opposite from the face (30) on which the mass (22) of the power amplifier (24) is fixed, the mass (21) of the antenna (20) being thermally connected to the mass (22) of the power amplifier (24).

4/ A device according to claim 3, characterized in that the mass (21) of the antenna (20) is thermally connected to the mass (22) of the power amplifier (24) by thermal bridges.

5/ A device according to claim 3, characterized in that the mass (21) of the antenna (20) is thermally connected to the mass (22) of the power amplifier (24) by plated-through holes (32) passing through the printed circuit (26).

6/ A device according to claim 4, characterized in that the mass (21) of the antenna (20) is thermally connected to the mass (22) of the power amplifier (24) by plated-through holes (32) passing through the printed circuit (26).
